(19) United States
(12) Patent Application Publication
(10) Pub. No.: US 2003/0147388 A1
(43) Pub. Date: Aug. 7, 2003

(54) Network broadcasting system

(75) Inventors: Stone Jinag, Chongqing (CN); Simon Qin, Chongqing (CN)

Correspondence Address: HOGAN & HARTSON L.L.P., 500 S. GRAND AVENUE, SUITE 1900, LOS ANGELES, CA, 90071-2611, US

(73) Assignee: FAR STONE TECH. INC.

(21) Appl. No.: 10/242,046

(22) Filed: Sep. 12, 2002

(30) Foreign Application Priority Data
Feb. 1, 2002 (TW) 91101763

(51) Int. Cl. H04L 12/28

(52) U.S. Cl. 370/390

(57) ABSTRACT

A network broadcasting system and methodology that unifies WAN protocol and LAN protocol. According to the invention, the network broadcasting system includes a server end and a client end. The server end includes at least one controlling unit and at least one processing unit, and the client end includes at least one receiving unit. The controlling unit is coupled to the processing unit, and the receiving unit is coupled to the processing unit. The receiving unit coupled to the processing unit receives information, orders and requests from the controlling unit to broadcast communication between the controlling unit and the receiving unit.

### BACKGROUND OF THE INVENTION

1. Field of the Invention

The present invention generally relates to network broadcasting system architecture technology. More specifically, the present invention relates to a network control and transmission system which unifies WAN protocol and LAN protocol to reduce data transmission capacity over the Internet.

2. Description of the Related Art

Network training software is a critical issue in modern multimedia network products. Generally speaking, the conventional network training software adopts client-server architecture. Client computers are used for students, and server computer is used for the teacher. The server computer is interconnected with the client computers nearby via LAN Focal area network), such as Ethernet. Therefore, the client computers can receive information transmitted from the server computer.

The server computer and the client computers need to install corresponding protocols, so that they can communicate in the same LAN. An example is a network training software wherein the server computer sends information on the monitor and sound of the teacher to the client computers.

The LAN environment is where there are destination addresses needed for TCP (Transmission Control Protocol) and UDP (User Datagram Protocol) to communicate each other.

In the case of broadcasting education, there are broadcasting addresses for all users to receive content of courses.

However, the conventional network training software is a LAN-based applications and can not interconnected the server computer with the client computers via WAN (wide-area network), for example, Internet, because the WAN environment can not use broadcasting addresses. In the WAN environment, Netmeeting, ICQ software or the like, can not carry out broadcast with socket communication. The broadcasting education can not work between the server computer and the client computers over Internet.

### SUMMARY OF THE INVENTION

The present invention provides methods and systems for broadcasting over the Internet. The systems and methods of the present invention also reduce the data transmission capacity, especially make good use of bandwidth and resources effectively, and improve the performance of the network broadcasting system with timely communication.

An object of the present invention is to provide a network broadcasting system and method, wherein WAN protocol is packaged to unify WAN protocol and LAN protocol.

Another object of the present invention is to provide a network control and transmission system and method, which can reduce the data transmission capacity over the Internet.

According to an aspect of the present invention, a network broadcasting system is provided, which comprises a server end and a client end. In particular, the server end includes at least one controlling unit and a processing unit, and the client end includes at least one receiving unit. The controlling unit is coupled to the processing unit, and the receiving unit is coupled to the processing unit. The receiving unit coupled to the processing unit receives information, orders and requests from the controlling unit to broadcast communication between the controlling unit and the receiving unit.

In the preferred embodiment of the invention, the controlling unit includes at least one computer for controlling screen broadcast, voice broadcast and screen monitoring. The processing unit includes at least one computer for processing the information, orders and requests from the controlling unit, and the receiving unit includes at least one computer for receiving the information, orders and requests from the processing unit. The processing unit transmits the processed information, orders and requests to the receiving unit. The processing unit sends a response of the receiving unit as feedback to the controlling unit. The receiving unit receives the information, orders and requests from the controlling unit through the processing unit. The network broadcasting system further comprises a communicating protocol to communicate the information, orders and requests from the controlling unit to the receiving unit. The information, orders and requests are transmitted to a part of the computers of the receiving unit through a part of the computers of the processing unit.

The network broadcasting system further comprises a monitoring unit, which monitors the part of the computers of the receiving unit to communicate status of the receiving unit to the controlling unit. The monitoring unit monitors the part of the computers of the receiving unit through the part of the computers of the processing unit.

In accordance with another aspect of the present invention, a network broadcasting system is provided, which comprises a server end and a client end. In particular, the server end includes at least one controlling unit, a first processing unit and a second processing unit, and the client end includes at least one receiving unit. The controlling unit is coupled to the first processing unit via a LAN, the first processing unit coupled to the second processing unit via a WAN, and the receiving unit is coupled to the second processing unit via a LAN. The receiving unit coupled to the processing unit receives information, orders and requests from the controlling unit to broadcast communication between the controlling unit and the receiving unit.

In the preferred embodiment of the invention, the controlling unit includes at least one computer for controlling screen broadcast, voice broadcast and screen monitoring. The first and the second processing unit each includes at least one computer for processing the information, orders and requests from the controlling unit respectively, and the receiving unit includes at least one computer for receiving the information, orders and requests from the second processing unit. The second processing unit transmits the processed information, orders and requests to the receiving unit. The second processing unit sends a response of the receiving unit as feedback to the controlling unit. The receiving unit receives the information, orders and requests from the controlling unit through the first and the second processing unit. The network broadcasting system further comprises a communicating protocol to communicate the information, orders and requests from the controlling unit to the receiving unit. The information, orders and requests are transmitted to a part of the computers of the receiving unit through a part of the computers of the first and the second processing unit. The network broadcasting system further comprises a monitoring unit which monitors the part of the computers of the receiving unit to communicate status of the receiving unit to the controlling unit. The monitoring unit monitors the part of the computers of the receiving unit through the part of the computers of the first and the second processing unit.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a block diagram of the network broadcasting system according to an embodiment of the present invention.

FIG. 2 is a block diagram of the network broadcasting system according to another embodiment of the present invention.

FIG. 3 is a block diagram of the network broadcasting system according to further embodiment of the present invention.

### DETAILED DESCRIPTION OF THE PREFERRED EMBODIMENTS

In the following description of the specific embodiments, a technique unifies WAN protocol and LAN protocol is utilized for making good use of bandwidth and resources effectively, and improves the performance of the network broadcasting system with timely communication. The present invention can provide methods and systems for broadcasting over the Internet, and reduce the data transmission capacity. However, it will be apparent to one skilled in the art that many network communication can be performed in a manner according to the present invention.

According to the preferred embodiment of the present invention, a network broadcasting system is installed in a computer system. The network broadcasting system comprises a server end and a client end. In particular, the server end includes at least one controlling unit and at least one processing unit, and the client end includes at least one receiving unit. The controlling unit is coupled to the processing unit, and the receiving unit is coupled to the processing unit. The receiving unit coupled to the processing unit receives information, orders and requests from the controlling unit to broadcast communication between the controlling unit and the receiving unit.

In the preferred embodiment of the invention, the controlling unit includes at least one computer for controlling screen broadcast, voice broadcast and screen monitoring. The processing unit includes at least one computer for processing the information, orders and requests from the controlling unit, and the receiving unit includes at least one computer for receiving the information, orders and requests from the processing unit. The processing unit transmits the processed information, orders and requests to the receiving unit. The processing unit sends a response of the receiving unit as feedback to the controlling unit. The receiving unit receives the information, orders and requests from the controlling unit through the processing unit. The network broadcasting system further comprises a communicating protocol to communicate the information, orders and requests from the controlling unit to the receiving unit. The information, orders and requests are transmitted to a part of the computers of the receiving unit through a part of the computers of the processing unit.

The network broadcasting system further comprises a monitoring unit, which monitors the part of the computers of the receiving unit to communicate status of the receiving unit to the controlling unit. The monitoring unit monitors the part of the computers of the receiving unit through the part of the computers of the processing unit.

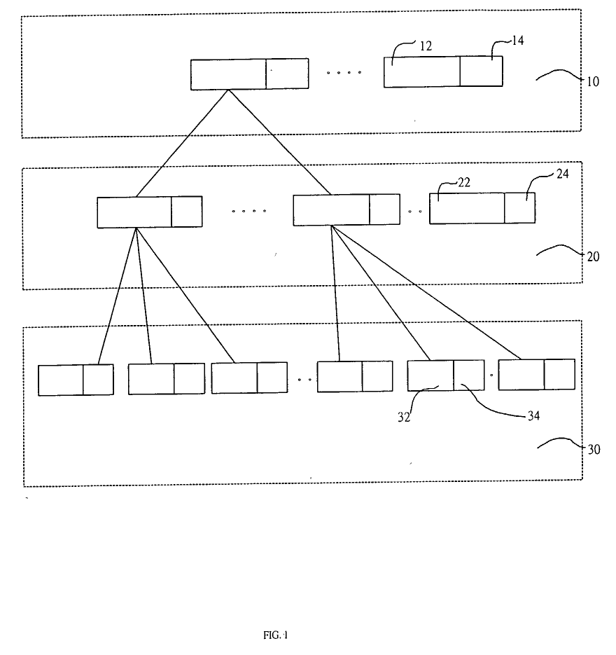

FIG. 1 is a block diagram of the network broadcasting system according to an embodiment of the present invention. In FIG. 1, the network broadcasting system includes a server end and a client end. The server end includes at least one controlling unit 10 and at least one processing unit 20, and the client end includes at least one receiving unit 30.

The controlling unit 10 is coupled to the processing unit 20 via a first communication channel. The first communication channel may be, for example, a WAN, such as Telephone dedicated line, satellite or Internet, etc. The processing unit 20 processes information, orders and requests from the controlling unit 10 to communicate instantly to the receiving unit 30 coupled to the processing unit 20 via a second communication channel. The second communication channel may be, for example, a LAN.

The controlling unit 10, the processing unit 20 and the receiving unit 30 has a communicating protocol 14, 24 and 34 respectively, each is a network control and transmission protocol, to provide network users a transport protocol consistent in LAN and WAN used to send information, orders and requests from the controlling unit 10 to the receiving unit 30.

The controlling unit 10 is a master control core, which includes at least one computer having at least one first server 12 for controlling screen broadcast, voice broadcast and screen monitoring.

The processing unit 20 includes at least one computer having at least one second server 22 for processing the information, orders and requests from the controlling unit 10. The processing unit 20 transmits the processed information, orders and requests to the receiving unit 30.

The receiving unit 30 includes at least one computer having at least one third server 32 for receiving the information, orders and requests from the processing unit 20. A hub is between the processing unit 20 and the receiving unit 30 to interconnect network and to allocate bandwidth for improving reliability of LAN system.

The message from the controlling unit 10 can send to the receiving unit 30 through the processing unit 20. The receiving unit 30 and the processing unit 20 receive information, orders and requests from the controlling unit 10 to broadcast communication.

The message from the controlling unit 10 may send to a single computer of the receiving unit 30 for one-to-one communication. The message from the controlling unit 10 may send to a plurality of computers of the receiving unit 30 for one-to-plural broadcast communication. The communication is proceeding through any, a group or all the computers of the processing unit 20 which is coupled to the receiving unit 30.

The processing unit 20 may send a response of the receiving unit 30 as feedback to the controlling unit 10. The controlling unit 10 and the processing unit 20 may replace reciprocally or may combine two into one. The controlling unit 10 and the receiving unit 30 may change positions or may combine two into one.

The network broadcasting system further comprises a monitoring unit, which monitors any, a group or all the computers of the receiving unit 30 to communicate status of the receiving unit 30 to the controlling unit 10. The monitoring unit monitors the receiving unit 30 through the connecting processing unit 20.

The message from the receiving unit 30 to the connecting processing unit 20 may send to the controlling unit 10 and may transfer to any, a group or all other computers of the receiving unit 30 through the connecting processing unit 20 to relay broadcast. The message received from the receiving unit 30 to the controlling unit 10 may send to any, a group or all other computers of the processing unit 20 and then transfer to any, a group or all other computers of the connecting receiving unit 30.

In the preferred embodiment of the invention, the network broadcasting system can solve problems in data broadcast resulted from the conventional WAN application software. The controlling unit 10 may couple to the processing unit 20 via WAN, and the processing unit 20 may couple to the receiving unit 30 via LAN. Alternatively, the controlling unit 10 may couple to the processing unit 20 via LAN, and the processing unit 20 may couple to the receiving unit 30 via WAN. Hence high efficiency data communication can be achieved.

According to another preferred embodiment of the present invention, a network broadcasting system is installed in a computer system. The network broadcasting system comprises a server end and a client end. In particular, the server end includes at least one controlling unit, at least one first processing unit and at least one second processing unit, and the client end includes at least one receiving unit. The controlling unit is coupled to the first processing unit. The first processing unit is coupled to the second processing unit. The receiving unit is coupled to the second processing unit. The receiving unit receives information, orders and requests from the controlling unit to broadcast communication between the controlling unit and the receiving unit.

In the preferred embodiment of the invention, the controlling unit includes at least one computer for controlling screen broadcast, voice broadcast and screen monitoring. The first and the second processing unit includes at least one computer for processing the information, orders and requests from the controlling unit respectively, and the receiving unit includes at least one computer for receiving the information, orders and requests from the second processing unit. The second processing unit transmits the processed information, orders and requests to the receiving unit. The second processing unit sends a response of the receiving unit as feedback to the controlling unit. The receiving unit receives the information, orders and requests from the controlling unit through the first and the second processing unit. The network broadcasting system further comprises a communicating protocol to communicate the information, orders and requests from the controlling unit to the receiving unit. The information, orders and requests are transmitted to a part of the computers of the receiving unit through a part of the computers of the first and the second processing unit.

The network broadcasting system further comprises a monitoring unit, which monitors the part of the computers of the receiving unit to communicate status of the receiving unit to the controlling unit. The monitoring unit monitors the part of the computers of the receiving unit through the part of the computers of the first and the second processing unit.

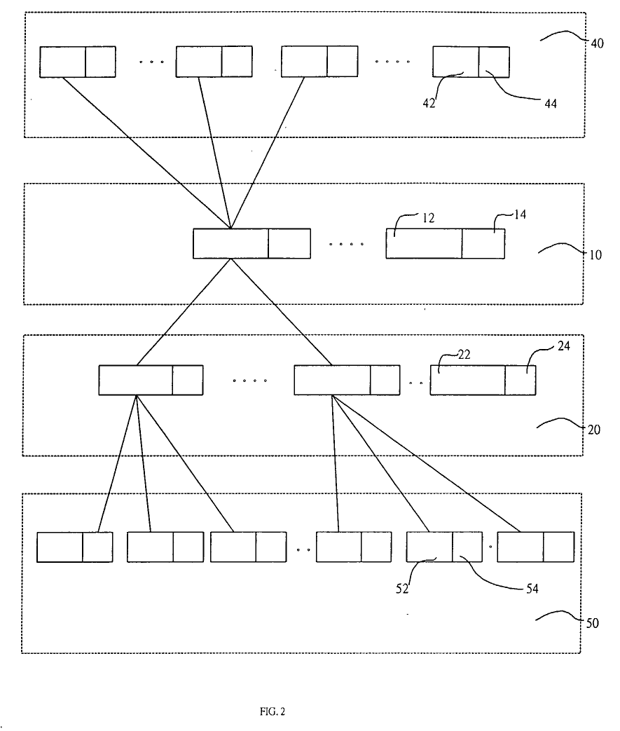

FIG. 2 is a block diagram of the network broadcasting system according to another embodiment of the present invention. In FIG. 2, the network broadcasting system includes a server end and a client end. The server end includes at least one controlling unit 10, a first processing unit 60 and a second processing unit 70, and the client end includes at least one receiving unit 30.

The controlling unit 10 is coupled to the first processing unit 60 via a second communication channel. The second communication channel may be, for example, a LAN. The first processing unit 60 is coupled to the second processing unit 70 via a first communication channel. The first communication channel may be, for example, a WAN, such as Telephone dedicated line, satellite or Internet, etc. The first processing unit 60 processes information, orders and requests from the controlling unit 10, then send such to the second processing unit 70 to further process and to communicate instantly to the receiving unit 30 coupled to the second processing unit 70 via a second communication channel. The first communication channel may be, for example, a LAN.

The controlling unit 10, the first processing unit 60, the second processing unit 70, and the receiving unit 30 has a communicating protocol 14, 64, 74 and 34 respectively, each is a network control and transmission protocol, to provide network users a transport protocol consistent in LAN and WAN used to send information, orders and requests from the controlling unit 10 to the receiving unit 30.

The controlling unit 10 is a master control core, which includes at least one computer having at least one first server 12 for controlling screen broadcast, voice broadcast and screen monitoring.

The first processing unit 60 and the second processing unit 70 each includes at least one computer having at least one second server 62 and 72 for processing the information, orders and requests from the controlling unit 10. The first processing unit 60 and the second processing unit 70 transmit the processed information, orders and requests to the receiving unit 30.

The receiving unit 30 includes at least one computer having at least one third server 32 for receiving the information, orders and requests from the second processing unit 70. Hubs which are between the controlling unit 10 and the first processing unit 60 and between the second processing unit 70 and the receiving unit 30 to interconnect network and to allocate bandwidth for improving reliability of LAN system.

The message from the controlling unit 10 can send to the receiving unit 30 through the first processing unit 60 and the second processing unit 70. The receiving unit 30, the first processing unit 60 and the second processing unit 70 receive information, orders and requests from the controlling unit 10 to broadcast communication.

The message from the controlling unit 10 may send to a single computer of the receiving unit 30 for one-to-one communication. The message from the controlling unit 10 may send to a plurality of computers of the receiving unit 30 for one-to-plural broadcast communication. The communication is proceeding through any, a group or all the computers of the first processing unit 60 and the second processing unit 70 which is coupled to the controlling unit 10 and the receiving unit 30.

The first processing unit 60 and the second processing unit 70 may send a response of the receiving unit 30 as feedback to the controlling unit 10. The controlling unit 10 and the first processing unit 60 may replace reciprocally or may combine two into one. The controlling unit 10 and the receiving unit 30 may change positions or may combine two into one.

The network broadcasting system further comprises a monitoring unit, which monitors any, a group or all the computers of the receiving unit 30 to communicate status of the receiving unit 30 to the controlling unit 10. The monitoring unit monitors the receiving unit 30 through the connecting first processing unit 60 and the connecting second processing unit 70.

The message from the receiving unit 30 to the connecting first processing unit 60 and the connecting second processing unit 70 may send to the controlling unit 10 and may transfer to any, a group or all other computers of the receiving unit 30 through the connecting first processing unit 60 and the connecting second processing unit 70 to relay broadcast. The message received from the receiving unit 30 to the controlling unit 10 may send to any, a group or all other computers of the first processing unit 60 and the second processing unit 70 and then transfer to any, a group or all other computers of the connecting receiving unit 30.

In the preferred embodiment of the invention, the network broadcasting system can solve problems in data broadcast resulted from the conventional WAN application software. The controlling unit 10 may couple to the first processing unit 60 via WAN, and the first processing unit 60 may couple to the second processing unit 70 via LAN, alternatively. The controlling unit 10 and the first processing unit 60 can be in the identical LAN, and the second processing unit 70 and the receiving unit 30 can be in the identical LAN. The controlling unit 10 can be in any computer of the receiving unit 30. Hence interconnect modes can be various and high efficiency data communication can be achieved.

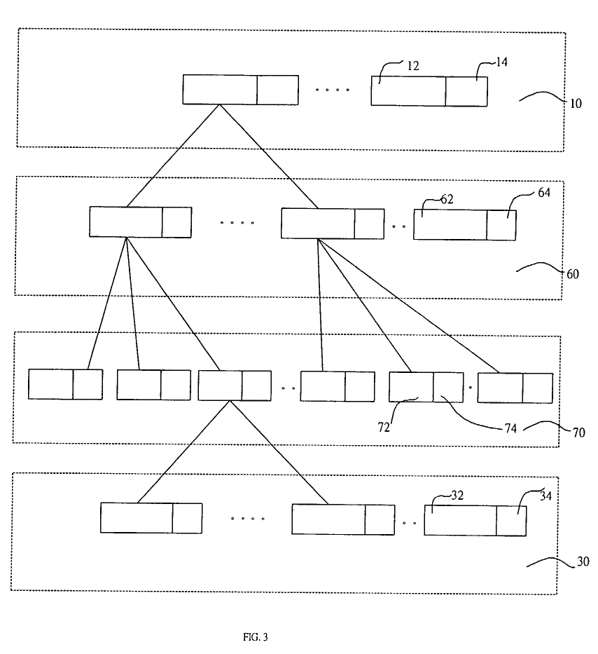

FIG. 3 is a block diagram of the network broadcasting system according to further embodiment of the present invention. In FIG. 3, the network broadcasting system includes a server end and a client end. The server end includes at least one controlling unit 10 and at least one processing unit 20, and the client end includes at least one first receiving unit 50 and at least one second receiving unit 40.

The controlling unit 10 is coupled to the processing unit 20 via a first communication channel. The first communication channel may be, for example, a WAN, such as Telephone dedicated line, satellite or Internet, etc. The processing unit 20 processes information, orders and requests from the controlling unit 10 to communicate instantly to the first receiving unit 50 coupled to the processing unit 20 via a second communication channel. The second communication channel may be, for example, a LAN. The controlling unit 10 may also be coupled to the second receiving unit 40 via a second communication channel to broadcast information, orders and requests.

The controlling unit 10, the processing unit 20, the first receiving unit 50 and the second receiving unit 40 each has a communicating protocol 14, 24, 54 and 44, each is a network control and transmission protocol, to provide network users a transport protocol consistent in LAN and WAN used to send information, orders and requests from the controlling unit 10 to the first receiving unit 50 and the second receiving unit 40 respectively.

The controlling unit 10 is a master control core, which includes at least one computer having at least one first server 12 for controlling screen broadcast, voice broadcast and screen monitoring.

The processing unit 20 includes at least one computer having at least one second server 22 for processing the information, orders and requests from the controlling unit 10. The processing unit 20 transmits the processed information, orders and requests to the first receiving unit 50.

The first receiving unit 50 and the second receiving unit 40 each includes at least one computer having at least one third server 32 for receiving the information, orders and requests from the processing unit 20 and the controlling unit 10 respectively. A hub is between the processing unit 20 and the receiving unit 30 to interconnect network and to allocate bandwidth for improving reliability of LAN system.

The message from the controlling unit 10 can send to the first receiving unit 50 through the processing unit 20. The message from the controlling unit 10 may send to the second receiving unit 40 directly. The first receiving unit 50, the second receiving unit 40 and the processing unit 20 receive information, orders and requests from the controlling unit 10 to broadcast communication.

The message from the controlling unit 10 may send to a single computer of the first receiving unit 50 or the second receiving unit 40 for one-to-one communication. The message from the controlling unit 10 may send to a plurality of computers of the first receiving unit 50 or the second receiving unit 40 or both for one-to-plural broadcast communication. The communication may be proceeding through any, a group or all the computers of the processing unit 20 which is coupled to the first receiving unit 50.

The processing unit 20 may send a response of the first receiving unit 50 as feedback to the controlling unit 10. The feedback from the second receiving unit 40 may send to the controlling unit 10 directly. The controlling unit 10 and the processing unit 20 may replace reciprocally or may combine two into one. The controlling unit 10 and the first receiving unit 50 may change positions or may combine two into one.

The network broadcasting system further comprises a monitoring unit, which monitors any, a group or all the computers of the first receiving unit 50 and the second receiving unit 40 to communicate status of the first receiving unit 50 and the second receiving unit 40 to the controlling unit 10. The monitoring unit may monitor the first receiving unit 50 through the connecting processing unit 20.

The message from the first receiving unit 50 to the connecting processing unit 20 may send to the controlling unit 10 and may transfer to any, a group or all other computers of the second receiving unit 40 coupled to the controlling unit 10, and may transfer to any, a group or all other computers of the first receiving unit 50 through the connecting processing unit 20 to relay broadcast.

The message received from the first receiving unit 50 and the second receiving unit 40 to the controlling unit 10 may send to any, a group or all other computers of the second receiving unit 40; and may send to any, a group or all other computers of the processing unit 20 and then transfer to any, a group or all other computers of the connecting first receiving unit 50.

In the preferred embodiment of the invention, the network broadcasting system can solve problems in data broadcast resulted from the conventional WAN application software. The controlling unit 10 and the second receiving unit 40 are in the identical LAN, and the processing unit 20 and the first receiving unit 50 are in the identical LAN. Hence interconnect modes can be various and high efficiency data communication can be achieved.

According to the preferred embodiment of the present invention, a network broadcasting system establishes a protocol information based on TCP/IP protocol and UDP protocol to exchange data packets on the various communication channels. With such protocol information packaging TCP/IP protocol, coding can unify WAN protocol and LAN protocol to emulate Internet. Therefore, the server end and the client end may communicate over various communication channels.

According to the preferred embodiment of the present invention, remote data demonstration and training can be achieved.

As described above, communication between branch offices can broadcast the information, orders and requests over various available communication channels while a branch office serves as a controlling unit. A network broadcasting system according to the preferred embodiment of the present invention uses a communicating protocol over a LAN and a WAN to communicate a message from said controlling unit to said receiving unit for broadcast.

According to the above description, it is evident that a network broadcasting system of the preferred embodiment of the present invention can communicate over various communication channels, with a protocol information based on TCP/IP protocol and UDP protocol, regardless of whether communication channels is a WAN. Data transmitted over Internet can be decreased greatly. Therefore, the present invention make good use of bandwidth and resources effectively, and improve the performance of the network broadcasting system with timely communication.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A network broadcasting system, comprising:
a server end including a controlling unit and a processing unit, said controlling unit coupled to said processing unit via a WAN; and
a client end including a receiving unit, said receiving unit coupled to said processing unit via a LAN, wherein
said receiving unit receives a message from said controlling unit to broadcast communication.

2. The network broadcasting system according to claim 1, wherein said controlling unit includes at least one computer for controlling screen broadcast, voice broadcast and screen monitoring, said processing unit includes at least one computer for processing said message from said controlling unit, and said receiving unit includes at least one computer for receiving said message from said processing unit.

3. The network broadcasting system according to claim 1, wherein said processing unit transmits said processed message to said receiving unit, and said receiving unit receives said processed message from said controlling unit through said processing unit.

4. The network broadcasting system according to claim 1, wherein said processing unit sends a response of said receiving unit as feedback back to said controlling unit.

5. The network broadcasting system according to claim 1, further comprising:
a communicating protocol for communicating said message from said controlling unit to said receiving unit.

6. The network broadcasting system according to claim 1, further comprising:
a monitoring unit for monitoring said receiving unit to communicate status of said receiving unit to said controlling unit, wherein
said controlling unit includes at least one computer for controlling screen broadcast, voice broadcast and screen monitoring, said processing unit includes at least one computer for processing said message from said controlling unit, and said receiving unit includes at least one computer for receiving said message from said processing unit, and said monitoring unit monitors a part of said at least one computer of said receiving unit through a part of said at least one computer of said processing unit.

7. The network broadcasting system according to claim 2, wherein said message is transmitted to a part of said at least one computer of said receiving unit through a part of said at least one computer of said processing unit.

8. A network broadcasting system, comprising:
a server end including a controlling unit and a processing unit, said controlling unit coupled to said processing unit via a WAN; and
a client end including a receiving unit, said receiving unit coupled to said processing unit via a LAN, wherein
said LAN and said WAN use a communicating protocol to communicate a message from said controlling unit to said receiving unit.

9. The network broadcasting system according to claim 8, wherein said controlling unit includes at least one computer for controlling screen broadcast, voice broadcast and screen monitoring, said processing unit includes at least one computer for processing said message from said controlling unit, and said receiving unit includes at least one computer for receiving said message from said processing unit.

10. The network broadcasting system according to claim 8, wherein said processing unit transmits said processed message to said receiving unit, and said receiving unit receives said processed message from said controlling unit through said processing unit.

11. The network broadcasting system according to claim 8, wherein said processing unit sends a response of said receiving unit as feedback back to said controlling unit.

12. The network broadcasting system according to claim 8, further comprising:
a monitoring unit for monitoring said receiving unit to communicate status of said receiving unit to said controlling unit.

13. The network broadcasting system according to claim 12, said controlling unit includes at least one computer for controlling screen broadcast, voice broadcast and screen monitoring, said processing unit includes at least one computer for processing said message from said controlling unit, and said receiving unit includes at least one computer for receiving said message from said processing unit, and said monitoring unit monitors a part of said at least one computer of said receiving unit through a part of said at least one computer of said processing unit.

14. The network broadcasting system according to claim 9, wherein said message is transmitted to a part of said computers of said receiving unit through a part of said computers of said processing unit.

15. A network broadcasting system, comprising:
a server end including a controlling unit, a first processing unit and a second processing unit, said controlling unit coupled to said first processing unit via a LAN, said first processing unit coupled to said second processing unit via a WAN; and
a client end including a receiving unit, said receiving unit coupled to said second processing unit via a LAN, wherein
said receiving unit coupled to said second processing unit receives a message from said controlling unit to broadcast communication.

16. The network broadcasting system according to claim 15, wherein said controlling unit includes at least one computer for controlling screen broadcast, voice broadcast and screen monitoring, said first and said second processing unit each includes at least one computer for processing said message from said controlling unit, and said receiving unit includes at least one computer for receiving said message from said second processing unit.

17. The network broadcasting system according to claim 15, wherein said second processing unit transmits said processed message to said receiving unit, said receiving unit receives said message from said controlling unit through said first and said second processing unit, and said second processing unit sends a response of said receiving unit as feedback back to said controlling unit.

18. The network broadcasting system according to claim 15, further comprising:
a communicating protocol for communicating said message from said controlling unit to said receiving unit, wherein
said controlling unit includes at least one computer for controlling screen broadcast, voice broadcast and screen monitoring, said first and said second processing unit each includes at least one computer for processing said message from said controlling unit, and said receiving unit includes at least one computer for receiving said message from said second processing unit, said message is transmitted to a part of said at least one computer of said receiving unit through a part of said at least one computer of said first and said second processing unit.

19. The network broadcasting system according to claim 15, further comprising:
a monitoring unit for monitoring said receiving unit to communicate status of said receiving unit to said controlling unit.

20. The network broadcasting system according to claim 19, wherein said controlling unit includes at least one computer for controlling screen broadcast, voice broadcast and screen monitoring, said first and said second processing unit each includes at least one computer for processing said message from said controlling unit, and said receiving unit includes at least one computer for receiving said message from said second processing unit, said monitoring unit monitors said part of said at least one computer of said receiving unit through said part of said at least one computer of said first and said second processing unit.
